(19) United States
(12) Patent Application Publication
(10) Pub. No.: US 2014/0293150 A1
(43) Pub. Date: Oct. 2, 2014

(54) TOUCH SCREEN

(71) Applicant: SHENZHEN O-FILM TECH CO., LTD, SHENZHEN CITY (CN)

(72) Inventors: GENCHU TANG, SHENZHEN CITY (CN); SHENGCAI DONG, SHENZHEN CITY (CN); WEI LIU, SHENZHEN CITY (CN); BIN TANG, SHENZHEN CITY (CN)

(73) Assignee: SHENZHEN O-FILM TECH CO., LTD, SHENZHEN CITY (CN)

(21) Appl. No.: 13/968,381

(22) Filed: Aug. 15, 2013

Related U.S. Application Data
(63) Continuation of application No. PCT/CN2013/079296, filed on Jul. 12, 2013.

(30) Foreign Application Priority Data
Apr. 2, 2013 (CN) 201310113688.X

(51) Int. Cl. G06F 3/041

(52) U.S. Cl. CPC G06F 3/041
USPC 349/12

(57) ABSTRACT

A touch screen, includes: a substrate, a coating adhesive layer, a first conductive strip and a second conductive strip, where the first and second conductive strips are composed of conductive grids embedded in the coating adhesive layer, and the first and second conductive strips space apart from each other along the thickness direction of the coating adhesive layer; a first electrode lead and a second electrode lead, where an end of the first electrode lead and an end of the second electrode lead are electrically connected to the first conductive strip and the second conductive strip respectively, the first electrode lead includes a penetrating portion and a lead portion, the penetrating portion extends from the side of the coating adhesive layer away from the substrate to a surface of the first conductive strip and is connected to the first conductive strip. The thickness of the touch screen is small.

### CROSS-REFERENCE TO RELATED APPLICATIONS

This application is a continuation of International Application No. PCT/CN2013/079296, filed on Jul. 12, 2013, which claims the priority benefit of Chinese Patent Application No. 201310113688.X, filed on Apr. 2, 2013, both of which are hereby incorporated by reference in their entireties.

### FIELD OF THE INVENTION

The present invention relates to the field of touch control technology, and specifically to a touch screen.

### BACKGROUND OF THE INVENTION

A touch screen is an inductive device capable of receiving an input signal such as a touch. The touch screen is a new and more attractive information interaction device that gives information interaction a new look. The development of touch screen technology has attracted extensive attention in information media at home and abroad, and the touch screen technology has become a high technology industry rising in the optoelectronic industry.

Currently, the mainstream ITO touch screens employ a G+G structure, in which two glass substrates are overlaid, ITO conductive pattern is formed on each of glass substrates, each ITO layer is connected to a flexible circuit board through a conductive lead, and the ITO conductive patterns on the two glass substrates spatially overlap with each other to form a structure similar to a capacitor. However, a touch screen with such a structure requires to overlay two glass substrates, increasing the thickness of the touch screen.

### SUMMARY OF THE INVENTION

Based on this, it is necessary to provide a touch screen with a relatively small thickness.

A touch screen, includes:

a substrate, including a first surface and a second surface opposite to the first surface;

a coating adhesive layer, provided on the first surface of the substrate;

a first conductive strip and a second conductive strip both embedded in the coating adhesive layer, where the first conductive strip and the second conductive strip each are composed of conductive grids embedded in the coating adhesive layer, the first conductive strip extends along a first direction, the second conductive strip extends along a second direction and away from the substrate with respect to the first conductive strip, the first conductive strip and the second conductive strip space apart from each other along a thickness direction of the coating adhesive layer, and a projection of the first conductive strip on a plane of the second conductive strip crosses over the second conductive strip;

a first electrode lead and a second electrode lead, formed on a side of the coating adhesive layer away from the substrate, where an end of the first electrode lead and an end of the second electrode lead are electrically connected to the first conductive strip and the second conductive strip respectively, the first electrode lead includes a penetrating portion embedded in the coating adhesive layer and a lead portion electrically connected with the penetrating portion, where the penetrating portion extends from the side of the coating adhesive layer away from the substrate to a surface of the first conductive strip and is connected to the first conductive strip.

In one embodiment, the conductive grid is composed of a plurality of conductive wires, and the penetrating portion is electrically connected with at least two conductive wires of the conductive grid forming the first conductive strip.

In one embodiment, the conductive grid is composed of a plurality of grid cells, each of the grid cells is a square, diamond, regular hexagon, rectangle or random grid shape.

In one embodiment, the conductive grid is composed of a plurality of conductive wires, the second electrode lead is a solid conductive strip, and the second electrode lead is electrically connected with at least two conductive wires of the conductive grid forming the second conductive strip.

In one embodiment, the second electrode lead includes a lead portion and a connecting portion formed at an end of the lead portion, and the connecting portion is electrically connected with at least two conductive wires of the conductive grid forming the second conductive strip.

In one embodiment, the lead portion of the first electrode lead is formed of a conductive grid and the second electrode lead is formed of a conductive grid.

In one embodiment, a grid cell of the conductive grid forming the lead portion of the first electrode lead and the second electrode lead are smaller than a grid cell forming the first conductive strip and the second conductive strip.

In one embodiment, an electrode tieline is further included, where the second electrode lead is electrically connected with at least two conductive wires of the conductive grid forming the second conductive strip via the electrode tieline.

In one embodiment, the second electrode lead includes a lead portion and a connecting portion formed at an end of the lead portion, and the connecting portion of the second electrode lead is electrically connected with the electrode tieline.

In one embodiment, the penetrating portion is cylindrical, and an end of the lead portion of the first electrode lead is electrically connected with the penetrating portion.

In one embodiment, the penetrating portion is cylindrical, a sleeve portion is formed at an end of the lead portion of the first electrode lead, where the sleeve portion is sleeved outside the end of the penetrating portion and electrically connected with the penetrating portion.

In one embodiment, the coating adhesive layer includes a first adhesive layer and a second adhesive layer stacked in sequence, where a first grid groove accommodating the first conductive strip is defined in a surface of the first adhesive layer away from the substrate, and a thickness of the first conductive strip is not larger than a depth of the first grid groove; the second adhesive layer covers the first adhesive layer and the first conductive strip, and a second grid groove accommodating the second conductive strip is defined in a surface of the second adhesive layer away from the substrate; and the penetrating portion runs through the second adhesive layer.

In one embodiment, a material of the first conductive strip and the second conductive strip is metal, graphene, carbon nanotube, indium tin oxide, or conductive macromolecules.

In one embodiment, there are a plurality of first conductive strips, and the plurality of first conductive strips are arranged along the second direction in sequence to form a first conductive layer.

In one embodiment, there are a plurality of second conductive strips, and the plurality of second conductive strips are arranged along the first direction in sequence to form a second conductive layer.

The above described touch screen, in which the first conductive strip and the second conductive strip are prepared by conductive grids, can save a lot of materials, thereby reducing the cost; the touch screen employs the combination of the glass substrate and the coating adhesive layer, greatly reducing the thickness compared to a conventional touch screen; an end of the first electrode lead and an end of the second electrode lead which are far away from the first conductive strip and the second conductive strip are adhered to a flexible circuit board, and the first electrode lead and the second electrode lead are located on the same side of the coating adhesive layer, which can simplify the structure of the flexible circuit board and adhering process, thus reduce the cost of the touch screen.

### BRIEF DESCRIPTION OF THE DRAWINGS

FIG. 1 is a schematic structural view of a touch screen according to an embodiment;

FIG. 2 is an exploded schematic structural view of the touch screen shown in FIG. 1;

FIG. 3 is a cross-sectional view taken along line III-III of the touch screen shown in FIG. 1;

FIG. 4 is a partial enlarged view at IV shown in FIG. 2;

FIG. 5 is a partial enlarged view of a second conductive layer and a second electrode lead according to another embodiment;

FIG. 6 to FIG. 8 are respective schematic views of the shapes of first electrode leads of touch screens according to various embodiments;

FIG. 9 is a schematic structural view of a second electrode lead and an electrode tieline of a touch screen according to another embodiment.

### DETAILED DESCRIPTION OF THE EMBODIMENTS

In order to facilitate understanding of the present invention, a comprehensive description of the present invention is given with reference to the accompanying drawings. The accompanying drawings show preferred embodiments of the present invention. However, the present invention may be implemented in many different forms, not limited to embodiments described herein. On the contrary, these embodiments are provided aiming to make disclosure of the present invention more thorough and comprehensive.

It should be noted that when an element is referred to as “fixed to” another element, it can be directly on the other element or an intermediate element may also exist. When an element is considered to be “connected” to another element, it can be directly connected to the other element or an intermediate element may exist at the same time.

Unless otherwise defined, all technical and scientific terms used herein have the same meaning as those commonly understood by persons skilled in the art to which the present invention pertains. Terms in specification of the present invention are merely used for describing specific embodiments, not intended to limit the present invention. As used herein, the term “and/or” includes any and all of combinations of one or more of associated listed items.

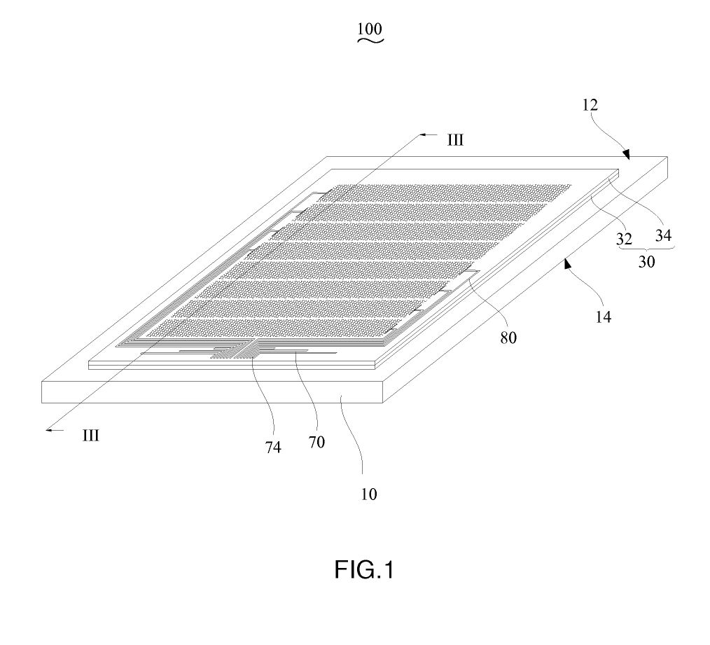

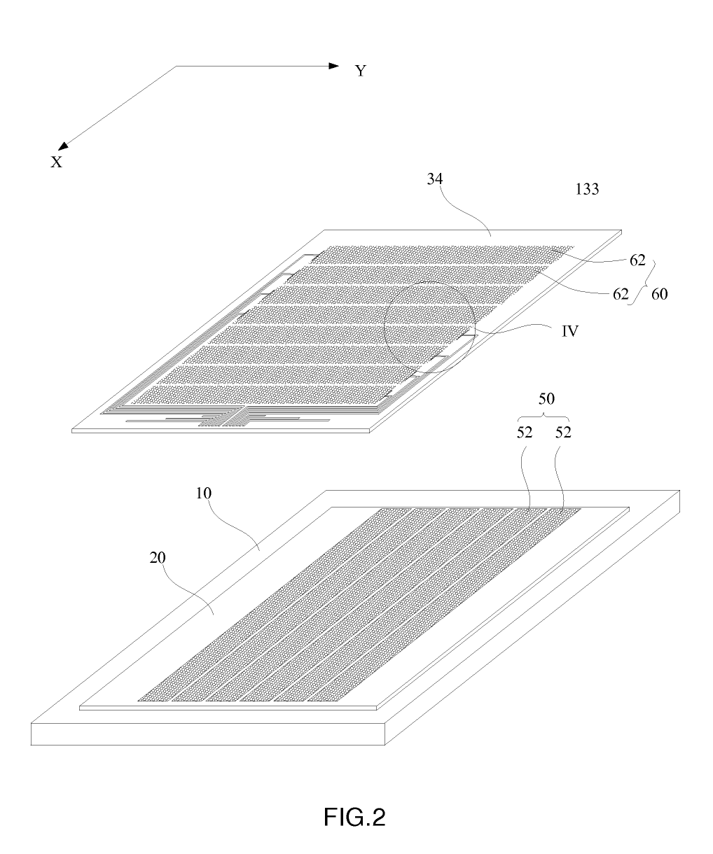

Refer to FIG. 1 and FIG. 2, a touch panel 100 of an embodiment includes a substrate 10, a coating adhesive layer 30, a first conductive layer 50, a second conductive layer 60, a first electrode lead 70, and a second electrode lead 80.

The material of the substrate 10 is glass or organic film. Specifically in this embodiment, the substrate 10 is a polyethylene terephthalate (PET) film. It should be noted that in other embodiments, the substrate 10 can be a film of other material, such as polybutylene terephthalate (PBT), polymethyl methacrylate (PMMA), and polycarbonate plastic (PC).

The substrate 10 includes a first surface 12 and a second surface 14 opposite to the first surface 12.

The coating adhesive layer 30 is attached to the first surface 12 of the substrate 10. The coating adhesive layer 30 is formed by curing a colloidal material which is coated on the substrate 10. Therefore, the thickness of the coating adhesive layer 30 is less than the thickness of the substrate 10. The coating adhesive layer 30 is formed of a transparent insulating material, and the material is different from the material of the substrate 10. Specifically, in this embodiment, the colloidal material forming the coating adhesive layer 30 is solvent-free UV-curable acrylic resin. In other embodiments, the colloidal material forming the coating adhesive layer 30 can also be light curing adhesive, thermosetting adhesive and self-dry adhesive. Wherein the light curing adhesive is a mixture of prepolymer, monomer, photoinitiator and additives in a molar ratio of 30˜50%, 40˜60%, 1˜6% and 0.2˜1%. Wherein the prepolymer is selected as at least one of epoxy acrylate, urethane acrylates, polyether acrylate, polyester acrylate, and acrylic resin; the monomer is at least one of monofunctional (IBOA, IBOMA, HEMA, etc.), bifunctional (TPGDA, HDDA, DEGDA, NPGDA, etc.), tri-functional and multi-functional (TMPTA, PETA, etc.) monomer; the photoinitiator is benzophenone, dihydroxyacetophenone, etc. Further, optionally additives may be added in the above mixture, where its molar ratio is 0.2˜1%. The additives may be hydroquinone, p-methoxyphenol, p-benzoquinone, or 2,6-di-tert-butyl-methylphenol.

Specifically in this embodiment, the coating adhesive layer 30 includes a first adhesive layer 32 and a second adhesive layer 34 stacked in sequence. It should be noted that the material of the first adhesive layer 32 and the second adhesive layer 34 may be the same or different.

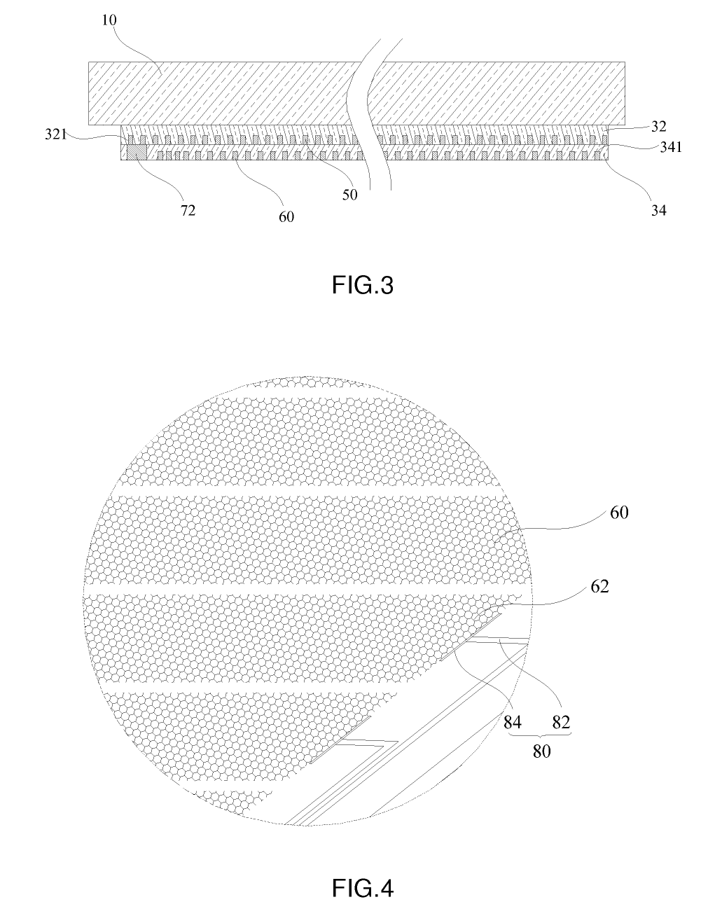

Refer to FIG. 2 and FIG. 3, the first adhesive layer 32 is attached to the first surface 12 of the substrate 10. A first grid groove 321 is provided on the surface of the first adhesive layer 32 away from the surface 10. The first grid groove 321 may be defined in the surface of the first adhesive layer 32 away from the surface 10 via embossing. And the shape of the first grid groove 321 may be embossed into a preset shape as required.

The first conductive layer 50 is accommodated in the first grid groove 321. Specifically, in this embodiment, the shape of the first conductive layer 50 matches with the shape of the first grid groove 321. Since the first grid groove 321 is embossed into a preset shape, a conductive material is filled into the first grid groove 321, and then hardened, thus the first conductive layer 50 can be formed. The first conductive layer 50 may be prepared by blade coating, etc., and does not need to be formed by etching, which accordingly can save materials and reduce cost.

The thickness of the first conductive layer 50 is less than the depth of the first grid groove 321, so that when the first conductive layer 50 is accommodated in the first grid groove 321, the first adhesive layer 32 may form protection for the first conductive layer 50, avoiding the first conductive layer 50 to be damaged in subsequent steps. Certainly, in other embodiments, the thickness of the first conductive layer 50 may be equal to the depth of the first grid groove 321.

In this embodiment, the first conductive layer 50 is a conductive grid composed of conductive wires intercrossing each other, and the conductive grid includes a plurality of grid cells. Specifically in this embodiment, the width of the conductive wire ranges between 500 nm˜5 μm. Specifically, nano-silver ink is filled into the first grid groove 321 using blade coating technique, and then sintered at a condition of 150° C., so as to sinter the silver elementary substance in the nano-silver ink into conductive wires. Where solid content of the silver ink is 35%, and solvent volatilizes during sintering. Since the shape of the first grid groove 321 is embossed into a desired pattern of the electrode in advance, no patterning operation is needed after the conductive grid is formed, thereby saving materials and improving efficiency. Certainly, the material of the first conductive layer 50 can also be other metal, graphene, carbon nanotube, indium tin oxide, or conductive macromolecules, now the first grid groove 321 can be filled with other materials.

The second adhesive layer 34 is overlaid on the surface of the first adhesive layer 32. The second adhesive layer 34 covers the first adhesive layer 32 and the first conductive strip 50. A second grid groove 341 is provided on the surface of the second adhesive layer 34 away from the surface 10. The second grid groove 341 may be defined in the surface of the second adhesive layer 34 away from the surface 10 via embossing. And the shape of the second grid groove 341 may be embossed into a preset shape as required.

The second conductive layer 60 is accommodated in the second grid groove 341. Specifically, in this embodiment, the shape of the second conductive layer 60 matches with the shape of the second grid groove 341. Since the second grid groove 341 is embossed into a preset shape, a conductive material is filled into the second grid groove 341, and then hardened, thus the second conductive layer 60 can be formed. The second conductive layer 60 may be formed without etching, which accordingly can save materials and reduce cost. The second conductive layer 60 and the first conductive layer 50 space apart from each other along the thickness direction of the coating adhesive layer 30.

The thickness of the second conductive layer 60 is less than the depth of the second grid groove 341, so that when the second conductive layer 60 is accommodated in the second grid groove 341, the second adhesive layer 34 may form protection for the second conductive layer 60, avoiding the second conductive layer 60 to be damaged in subsequent steps. Certainly, in other embodiments, the thickness of the second conductive layer 60 may be equal to the depth of the second grid groove 341.

In this embodiment, the second conductive layer 60 is a conductive grid composed of conductive wires intercrossing each other, and the conductive grid includes a plurality of grid cells. Specifically in this embodiment, the width of the conductive wire ranges between 500 nm˜5 μm. Specifically, nano-silver ink is filled into the second grid groove 341 using blade coating technique, and then sintered at a condition of 150° C., so as to sinter the silver elementary substance in the nano-silver ink into conductive wires. Where solid content of the silver ink is 35%, and solvent volatilizes during sintering. Since the shape of the second grid groove 341 is embossed into a desired pattern of the electrode in advance, no patterning operation is needed after the conductive grid is formed, thereby saving materials and improving efficiency. Certainly, the material of the second conductive layer 60 can also be other metal, graphene, carbon nanotube, indium tin oxide, or conductive macromolecules, now the second grid groove 341 can be filled with other materials.

The first conductive layer 50 is composed of a group of the first conductive strips 52 extending along a first direction X. A plurality of the first conductive strips 52 are arranged along a second direction Y. In this embodiment, the first direction X and the second direction Y are substantially perpendicular to each other, and the first direction X and the second direction Y are parallel to the first surface 12.

The second conductive layer 60 is composed of a group of second conductive strips 62 extending along the second direction Y. A plurality of the second conductive strips 52 are arranged along the first direction X. Projection of the first conductive strips 52 on the plane of the second conductive strips 62 crosses over the second conductive strips 62.

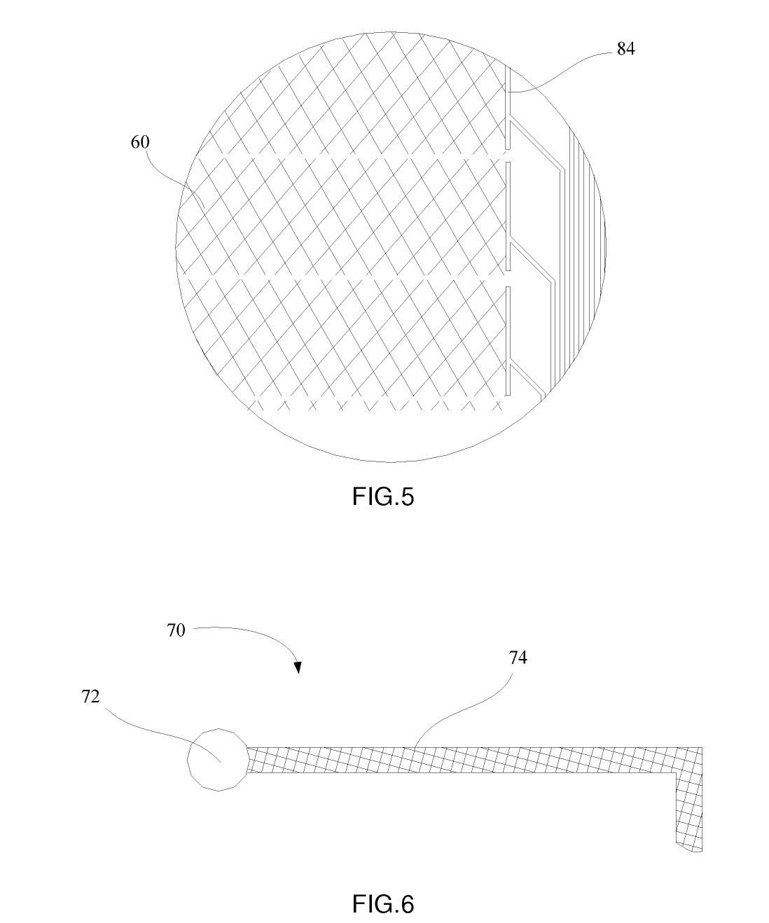

See also FIG. 4, in this embodiment, a grid cell of the conductive grid of the first conductive layer 50 and the second conductive layer 60 is a regular hexagon, and a plurality of grid cells constitute honeycomb-like structure. Certainly, in other embodiments, the grid can also be rectangle, parallelogram or curved quadrilateral, where the curved quadrilateral has four curved sides, with two opposite curved sides having the same shape and curve direction. For example, the grid cell in FIG. 5 is diamond.

In order to further improve light transmittance, the first conductive layer 50 and the second conductive layer 60 should overlap to an extreme, so as to reduce the area of a visible region occupied by the two layers of metal grid, thus improve light transmittance. Preferably, the grid cells of the second conductive layer 60 and the grid cells of the first conductive layer 50 completely overlap, where by the grid cells completely overlapping it means the width of the conductive wire of the grid cells is equal, and each grid cell has the same shape and equal area, each conductive wire of the first conductive layer 50 faces directly toward each conductive wire of the second conductive layer 60, and the projection of the first conductive layer 50 on the plane of the second conductive layer 60 coincides with the second conductive layer 60.

The conductive grids of the first conductive layer 50 and the second conductive layer 60 overlap so that the conductive wire of the conductive grid of the second conductive layer 60 and the conductive wire of the conductive grid of the first conductive layer 50 will not block each other, so as to reduce the area of the visible region occupied by the two layers of conductive grid, thus improve light transmittance.

Refer to FIG. 1 to FIG. 3, the first electrode lead 70 includes a penetrating portion 72 and a lead portion 74. The penetrating portion 72 is embedded in the second adhesive layer 34. The penetrating portion 72 extends from a surface of the second adhesive layer 34 away from the substrate 10 to the first conductive layer 50, so that an end of the penetrating portion 72 is electrically connected to the first conductive layer 50. A through-hole is formed in the second adhesive layer 34 for accommodating the penetrating portion 72. The through-hole is formed through rubber stopper, that is, prepared through exposure and developing of photoresist. The penetrating portion 72 is prepared by filling conductive materials into the through-hole. Since the first conductive layer 50 is formed of the conductive grid, the penetrating portion 72 is electrically connected with at least two conductive wires of the conductive grid. An end of the lead portion 74 is electrically connected with an end of the penetrating portion 72 away from the first conductive layer 50. In the touch screen 100, the first electrode lead 70 is used to electrically connect the first conductive layer 50 to a controller of an electronic device, specifically in this embodiment, the other end of the lead portion 74 is electrically connected to a flexible circuit board, and then electrically connected to the controller of the electronic device, thereby making the controller sense operation on the touch screen 100.

In this embodiment, a groove for accommodating the lead portion 74 of the first electrode lead 70 is defined in the surface of the second adhesive layer 34 away from the substrate 10, where the lead portion 74 of the first electrode lead 70 is accommodated in the groove. The lead portion 74 of the first electrode lead 70 is a solid conductive strip. The thickness of the lead portion 74 of the first electrode lead 70 is smaller than the depth of the groove, so that when the lead portion 74 is accommodated in the groove, the second adhesive layer 34 may form protection for the lead portion 74, avoiding the lead portion 74 to be damaged in subsequent steps. Certainly, in other embodiments, the thickness of the lead portion 74 may be equal to the groove depth. Further, in other embodiments, the groove for accommodating the lead portion 74 may be omitted, in this case the lead portion 74 of the first electrode lead 70 is arranged on the surface of the second adhesive layer 34 away from the substrate 10.

Refer to FIG. 6, in another embodiment, the lead portion 74 of the first electrode lead 70 is formed of a conductive grid which is composed of conductive wires intercrossing each other in a grid. The grid cycle of the conductive grid of the lead portion 74 is smaller than the grid cycle of the conductive grid of the first conductive layer 50, where the grid cycle is the size of a grid cell. The penetrating portion 72 is substantially cylindrical, and an end of the lead portion 74 is electrically connected to the penetrating portion 72.

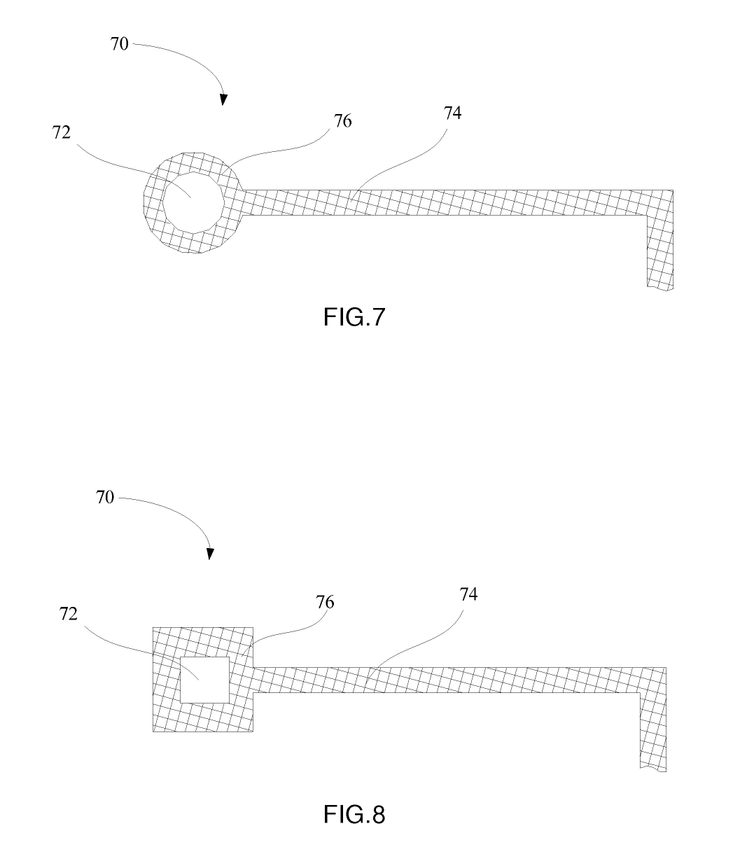

Refer to FIG. 7, in another embodiment, the first electrode lead 70 further includes a sleeve portion 76 formed integrally with the lead portion 74. The lead portion 74 and the sleeve portion 76 of the first electrode lead 70 are formed of conductive grids which are composed of conductive wires intercrossing each other in a grid. Grid cycles of the conductive grid of the lead portion 74 and the sleeve portion 76 are smaller than the grid cycle of the conductive grid of the first conductive layer 50, wherein the grid cycle is the size of a grid cell. The penetrating portion 72 is substantially cylindrical, and the sleeve portion 76 is sleeved outside an end of the penetrating portion 72, which can increase contact area of the sleeve portion 76 and the penetrating portion 72, thereby improve the stability of the first electrode lead 70.

Refer to FIG. 8, in another embodiment, the first electrode lead 70 further includes a sleeve portion 76 formed integrally with the lead portion 74. The lead portion 74 and the sleeve portion 76 of the first electrode lead 70 are formed of conductive grids which are composed of conductive wires intercrossing each other in a grid. Grid cycles of the conductive grid of the lead portion 74 and the sleeve portion 76 are smaller than the grid cycle of the conductive grid of the first conductive layer 50, where the grid cycle is the size of a grid cell. The penetrating portion 72 is substantially quadrangular, and the sleeve portion 76 is sleeved outside an end of the penetrating portion 72, which can increase contact area of the sleeve portion 76 and the penetrating portion 72, thereby improve the stability of the first electrode lead 70.

See FIG. 4 again, the second electrode lead 80 includes a lead portion 82 and a connecting portion 84 formed at an end of the lead portion 82. In the touch screen 100, the second electrode lead 80 is used to electrically connect the second conductive layer 60 to a controller of an electronic device, specifically in this embodiment, the other end of the lead portion 82 is electrically connected to a flexible circuit board, and then electrically connected to the controller of the electronic device via the flexible circuit board, thereby making the controller sense operation on the touch screen 100. In this embodiment, the second electrode lead 80 is a solid conductive strip, and the connecting portion 84 is electrically connected with at least two conductive wires in the conductive grid of the second conductive strip 62 in the second conductive layer 60.

In this embodiment, a groove for accommodating the second electrode lead 80 is defined in the surface of the second adhesive layer 34 away from the substrate 10, where the second electrode lead 80 is accommodated in the groove. The second electrode lead 80 is a solid conductive strip. The thickness of the second electrode lead 80 is smaller than the depth of the groove, so that when the second electrode lead 80 is accommodated in the groove, the second adhesive layer 34 may form protection for the second electrode lead 80, avoiding the second electrode lead 80 to be damaged in subsequent steps. Certainly, in other embodiments, the thickness of the second electrode lead 80 may be equal to the groove depth. Further, in other embodiments, the groove for accommodating the second electrode lead 80 may be omitted, in this case the second electrode lead 80 is arranged on the surface of the second adhesive layer 34 away from the substrate 10.

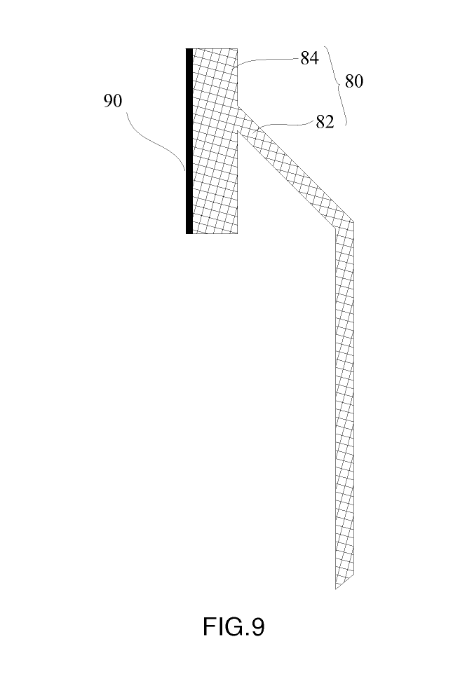

Refer to FIG. 1 and FIG. 9, in another embodiment, the second electrode lead 80 is formed of a conductive grid which is composed of conductive wires intercrossing each other in a grid. The grid cycle of the conductive grid of the second electrode lead 80 is smaller than the grid cycle of the conductive grid of the second conductive layer 60, where the grid cycle is the size of a grid cell. Since the grid cycle of the conductive grid of the second electrode lead 80 is different from the grid cycle of the conductive grid of the second conductive layer 60, it may be difficult to align when the connecting portion 84 of the second electrode lead 80 is electrically connected to the second conductive layer 60. Therefore, further, the touch screen 100 also includes an electrode tieline 90. The connecting portion 84 is electrically connected with the second conductive layer 60 via the electrode tieline 90. The electrode tieline 90 is a continuous conductive wire, so that the electrode tieline 90 can be electrically connected with at least two conductive wires in the conductive grid of the connecting portion 84 of the second electrode lead 80 and simultaneously electrically connected with at least two conductive wires in the conductive grid of the second conductive layer 60, thus making the second electrode lead 80 be electrically connected with the second conductive layer 60 better.

Compared with a conventional touch screen induction module, the above described touch screen 100 has at least following advantages:

1. The first conductive layer 50 and the second conductive layer 60 are accommodated respectively in the first grid groove 321 and the second grid groove 341, so that preparation of the first conductive layer 50 and the second conductive layer 60 can be achieved by blade coating, without the need of etching, which can save materials and reduce cost;

2. The grid cells of the first conductive layer 50 and the second conductive layer 60 can achieve a visual effect of transparency through controlling the width and density of the conductive wires; the conductive grids of the first conductive layer 50 and the second conductive layer 60 overlap so that the conductive wire of the conductive grid of the second conductive layer 60 and the conductive wire of the conductive grid of the first conductive layer 50 will not block each other, so as to reduce the area of a visible region occupied by the two layers of conductive grid, thus improve light transmittance.

3. The touch panel 100 employs the combination of the substrate 10 and the coating adhesive layer 30, greatly reducing the thickness compared to conventional two layers of glass substrates;

4. An end of the first electrode lead 70 and an end of the second electrode lead 80 which are far away from the first conductive layer 50 and the second conductive layer 60 are adhered to a flexible circuit board, and the first electrode lead 70 and the second electrode lead 80 are located on the same side of the coating adhesive layer 30, which can simplify the structure of the flexible circuit board and adhering process, thus reduce the cost of the touch screen 100.

It should be noted that one of the first adhesive layer 32 and the second adhesive layer 34 may be omitted, in this case the coating adhesive layer 30 is a single-layer structure. The first conductive layer 50 and the second conductive layer 60 are both embedded in the coating adhesive layer 30, the second conductive layer 60 and the first conductive layer 50 space apart from each other along the thickness direction of the coating adhesive layer 30, and the second conductive layer 60 is far away from the substrate 10 with respect to the first conductive layer 50.

The above described embodiments merely show some implementing modes of the present invention with specific details, they should not be considered as limiting the scope of the present invention. It should be noted that, modifications and improvements can be made by persons skilled in the art without departing from the concept of the present invention, and such modifications or improvements should fall within the scope of the present invention. Accordingly, the scope of the present invention should be subject to the claims.

What is claimed is:

1. A touch screen, comprising:
a substrate, comprising a first surface and a second surface opposite to the first surface;
a coating adhesive layer, provided on the first surface of the substrate;
a first conductive strip and a second conductive strip both embedded in the coating adhesive layer, wherein the first conductive strip and the second conductive strip each are composed of conductive grids embedded in the coating adhesive layer, the first conductive strip extends along a first direction, the second conductive strip extends along a second direction and away from the substrate with respect to the first conductive strip, the first conductive strip and the second conductive strip space apart from each other along a thickness direction of the coating adhesive layer, and a projection of the first conductive strip on a plane of the second conductive strip crosses over the second conductive strip;
a first electrode lead and a second electrode lead, formed on a side of the coating adhesive layer away from the substrate, wherein an end of the first electrode lead and an end of the second electrode lead are electrically connected to the first conductive strip and the second conductive strip, respectively, the first electrode lead comprises a penetrating portion embedded in the coating adhesive layer and a lead portion electrically connected with the penetrating portion, wherein the penetrating portion extends from the side of the coating adhesive layer away from the substrate to a surface of the first conductive strip and is connected to the first conductive strip.

2. The touch screen according to claim 1, wherein the conductive grid is composed of a plurality of conductive wires, and the penetrating portion is electrically connected with at least two conductive wires of the conductive grid forming the first conductive strip.

3. The touch screen according to claim 1, wherein the conductive grid is composed of a plurality of grid cells, each of the grid cells is a square, diamond, regular hexagon, rectangle or random grid shape.

4. The touch screen according to claim 1, wherein the conductive grid is composed of a plurality of conductive wires, the second electrode lead is a solid conductive strip, and the second electrode lead is electrically connected with at least two conductive wires of the conductive grid forming the second conductive strip.

5. The touch screen according to claim 4, wherein the second electrode lead comprises a lead portion and a connecting portion formed at an end of the lead portion, and the connecting portion is electrically connected with at least two conductive wires of the conductive grid forming the second conductive strip.

6. The touch screen according to claim 1, wherein the lead portion of the first electrode lead is formed of a conductive grid and the second electrode lead is formed of a conductive grid.

7. The touch screen according to claim 6, wherein a grid cell of the conductive grid forming the lead portion of the first electrode lead and the second electrode lead are smaller than a grid cell forming the first conductive strip and the second conductive strip.

8. The touch screen according to claim 6, further comprising an electrode tieline, wherein the second electrode lead is electrically connected with at least two conductive wires of the conductive grid forming the second conductive strip via the electrode tieline.

9. The touch screen according to claim 8, wherein the second electrode lead comprises a lead portion and a connecting portion formed at an end of the lead portion, and the connecting portion of the second electrode lead is electrically connected with the electrode tieline.

10. The touch screen according to claim 6, wherein the penetrating portion is cylindrical, and an end of the lead portion of the first electrode lead is electrically connected with the penetrating portion.

11. The touch screen according to claim 6, wherein the penetrating portion is cylindrical, a sleeve portion is formed at an end of the lead portion of the first electrode lead, wherein the sleeve portion is sleeved outside the end of the penetrating portion and electrically connected with the penetrating portion.

12. The touch screen according to claim 1, wherein the coating adhesive layer comprises a first adhesive layer and a second adhesive layer stacked in sequence, wherein a first grid groove accommodating the first conductive strip is defined in a surface of the first adhesive layer away from the substrate, and a thickness of the first conductive strip is not larger than a depth of the first grid groove; the second adhesive layer covers the first adhesive layer and the first conductive strip, and a second grid groove accommodating the second conductive strip is defined in a surface of the second adhesive layer away from the substrate; and the penetrating portion runs through the second adhesive layer.

13. The touch screen according to claim 1, wherein a material of the first conductive strip and the second conductive strip is metal, graphene, carbon nanotube, indium tin oxide, or conductive macromolecules.

14. The touch screen according to claim 1, wherein there are a plurality of first conductive strips, and the plurality of first conductive strips are arranged along the second direction in sequence to form a first conductive layer.

15. The touch screen according to claim 1, wherein there are a plurality of second conductive strips, and the plurality of second conductive strips are arranged along the first direction in sequence to form a second conductive layer.
